(19) United States
(12) Patent Application Publication
(10) Pub. No.: US 2024/0381474 A1
(43) Pub. Date: Nov. 14, 2024

(54) METHOD, APPARATUS AND COMPUTER PROGRAM FOR TRANSMITTING NAS MESSAGE

(71) Applicant: Nokia Technologies Oy, Espoo (FI)

(72) Inventors: Rachit MAHENDRA, Khairabad (IN); Bent Henneberg RYSGAARD, Aalborg (DK); Smita SHETTY, Bengaluru (IN)

(21) Appl. No.: 18/659,069

(22) Filed: May 9, 2024

(30) Foreign Application Priority Data
May 12, 2023 (IN) 202311033603

(51) Int. Cl. H04W 76/20; H04W 24/08; H04W 56/00

(52) U.S. Cl. CPC H04W 76/20; H04W 24/08; H04W 56/0045

(57) ABSTRACT

A method may include determining that a user equipment is in a radio resource control, RRC, non-connected state. The method may also include broadcasting a system information block, SIB, to a plurality of user equipment including the user equipment. The system information block SIB includes a non-access stratum, NAS, container for conveying a NAS message to the user equipment. In the method, the RRC non-connected state includes an RRC inactive state or an RRC idle state.

### FIELD OF INVENTION

The teachings in accordance with the embodiments of this invention relate generally to method and apparatus for transmitting to user equipment layer 3 NAS message in RRC non-connected state.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| Abbreviations | Description |
|---|---|
| 3GPP | Third Generation Partnership Project |
| 5G NR | Fifth Generation New Radio |
| 5GS | 5G System |
| AT | ATtention! Hayes compatible command. |
| BCH | Broadcast Channel |
| CG | Configured Grant |
| CG-SDT | Configured Grant Based SDT |
| CORESET | Control Resource Set |
| DL | Downlink |
| DL-SCH | Downlink Shared Channel |
| DUT | Device Under Test |
| EMMI | Electrical Man Machine Interface |
| FR2 | Frequency Range 2 |
| gNB | gNodeB |
| MIB | Master Information Block |
| MO-SDT | Mobile Originated SDT |
| NAS | Non-Access Stratum |
| PBCH | Physical Broadcast Channel |
| PCell | Primary Cell |
| PDCCH | Physical Downlink Control Channel |
| PDSCH | Physical Downlink Shared Channel |
| RA | Random Access |
| RAN4 | Radio Access Network Working Group 4 |
| RAN5 | Radio Access Network Working Group 5 |
| Rel-17 | Release 17 |
| RMSI | Remaining Minimum SI |
| RRC | Radio Resource Control |
| RRM | Radio Resource Management |
| RSRP | Reference Signal Received Power |
| SDT | Small Data Transmission |
| SI | System Information |
| SIB1 | System Information Block 1 |
| SS | System Simulator |
| SSB | Synchronization Signal Block |
| TA | Timing Advance |
| TAC | Timing Advance Command |
| TE | Test Equipment |
| TMC | Test Mode Control |
| TS | Technical Specification |
| UE | User Equipment |
| UL | Uplink |
| UL-SDT | Uplink SDT |
| V2X | Vehicle To Everything |

To support 5GS conformance testing, UE special conformance test functions are required. They form a part of the core requirements and thus have a direct impact on the design of the UE. The UE special conformance test functions vary depending on the conformance testing functionality they are designed to support and are broadly classified into the following two groups:

Test Loop Functions: Functions which require a loop to be established between the UE and the System Simulator (SS) to allow, e.g., DL data packets sent by the SS to be looped back UL by the UE

General Test Functions: Commands send by the SS, e.g., to trigger a certain UE behavior which may be a behavior determined by 3GPP core spec requirements or such needed to facilitate conformance testing and not being part of any 3GPP core spec requirements, or, to provide to the UE information needed for the conformance testing.

The utilization of any UE special conformance test functions be considered as putting the UE in a test mode. The duration of the test mode depends on the UE special conformance test function and in most of the cases, the test mode be delimited by an activation and a deactivation command. The UE special conformance test functions including any relevant procedure and the Test Mode Control (TMC) message contents used for information exchange are defined in 3GPP TS 36.509 (base version for LTE) and 38.509 (extensions for NR).

The UE special conformance test functions provide access to isolated functions of the UE via the radio interface without introducing new physical interfaces just for the reason of conformance testing.

As per the 3GPP specification available by the time, there is no method through which these test control commands can be sent to the UE in the non-connected state including RRC IDLE state and RRC INACTIVE state if the UE has not initiated an SDT procedure. This means that to send each test mode command, the UE must be brought back to the RRC CONNECTED state. This requires additional message exchanges between SS and the UE which are unnecessary from the test point of view.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

According to a first example embodiment, a method may include determining that a user equipment is in a radio resource control, RRC, non-connected state. The method may also include broadcasting a system information block, SIB, to a plurality of user equipment including the user equipment. The system information block SIB includes a non-access stratum, NAS, container for conveying a NAS message to the user equipment.

In the method of the first example embodiment, the RRC non-connected state includes an RRC inactive state or an RRC idle state.

In the method of the first example embodiment, the system information block SIB is an existing SIB or a new SIB.

In the method of the first example embodiment, the NAS message instructs the user equipment to perform a particular action and the method further includes transmitting an indication to the user equipment instructing the user equipment to not send a NAS completion message following the completion of the particular action.

In the method of the first example embodiment, the indication is transmitted as part of the SIB.

In the method of the first example embodiment, the NAS message is expanded to include the indication.

In the method of the first example embodiment, the user equipment is subject to a conformance test procedure while the user equipment is in the RRC non-connected state, and the NAS message is a test control command related to the conformance test procedure.

In the method of the first example embodiment, the test control command is one of the following:
a command for activating a test mode;
a command for de-activating a test mode;
a command for closing a user equipment test loop; or
a command for opening a user equipment test loop.

In the method of the first example embodiment, the conformance test procedure is for testing validation by the user equipment of a last-used timing advance value for a configured grant small data transmission procedure.

According to second example embodiment, a network node may include means for determining that a user equipment is in a radio resource control, RRC, non-connected state. The network node may also include means for broadcasting a system information block, SIB, to a plurality of user equipment including the user equipment. The system information block SIB includes a non-access stratum, NAS, container for conveying a NAS message to the user equipment.

In the network node of the second example embodiment, the RRC non-connected state includes an RRC inactive state or an RRC idle state.

In the network node of the second example embodiment, the system information block SIB is an existing SIB or a new SIB.

In the network node of the second example embodiment, the NAS message instructs the user equipment to perform a particular action. The network node further comprises means for transmitting an indication to the user equipment, the indication instructing the user equipment to not send a NAS completion message following the completion of the particular action.

In the network node of the second example embodiment, the indication is transmitted as part of the SIB.

In the network node of the second example embodiment, the NAS message is expanded to include the indication.

In the network node of the second example embodiment, the user equipment is subject to a conformance test procedure while the user equipment is in the RRC non-connected state, and the NAS message is a test control command related to the conformance test procedure.

In the network node of the second example embodiment, the test control command is one of the following:
a command for activating a test mode;
a command for de-activating a test mode;
a command for closing a user equipment test loop; or
a command for opening a user equipment test loop.

In the network node of the second example embodiment, the conformance test procedure is for testing validation by the user equipment of a last-used timing advance value for a configured grant small data transmission procedure.

According to a third example embodiment, a network node may include at least one processing circuitry or processor. The network node may also include at least one memory including computer program code. The at least one memory and the computer program code may be configured, with the at least one processing circuitry or processor, to cause the network node at least to determine that a user equipment is in a radio resource control, RRC, non-connected state. The network node may also be caused to broadcast a system information block, SIB, to a plurality of user equipment including the user equipment. The system information block SIB includes a non-access stratum, NAS, container for conveying a NAS message to the user equipment.

In the network node of the third example embodiment, the RRC non-connected state includes an RRC inactive state or an RRC idle state.

In the network node of the third example embodiment, the system information block SIB is an existing SIB or a new SIB.

In the network node of the third example embodiment, the NAS message instructs the user equipment to perform a particular action. The network node transmits an indication to the user equipment, the indication instructing the user equipment to not send a NAS completion message following the completion of the particular action.

In the network node of the third example embodiment, the indication is transmitted as part of the SIB.

In the network node of the third example embodiment, the NAS message is expanded to include the indication.

In the network node of the third example embodiment, the user equipment is subject to a conformance test procedure while the user equipment is in the RRC non-connected state, and the NAS message is a test control command related to the conformance test procedure.

In the network node of the third example embodiment, the test control command is one of the following:
a command for activating a test mode;
a command for de-activating a test mode;
a command for closing a user equipment test loop; or
a command for opening a user equipment test loop.

In the network node of the third example embodiment, the conformance test procedure is for testing validation by the user equipment of a last-used timing advance value for a configured grant small data transmission procedure.

According to fourth example embodiment, a computer program product may be embodied on a non-transitory computer readable medium. The computer program product may be configured to control a processor to perform a method according to the first embodiment.

According to fifth example embodiment, a method may include transitioning in a radio resource control, RRC, non-connected state. The method may also include receiving a system information block, SIB, from a network node. The system information block SIB includes a non-access stratum, NAS, container for conveying a NAS message to the user equipment.

In the method of the fifth example embodiment, the RRC non-connected state includes an RRC inactive state or an RRC idle state,

In the method of the fifth example embodiment, the SIB is an existing SIB or a new SIB.

In the method of the fifth example embodiment, the NAS message instructs the user equipment to perform a particular action. The method further includes receiving an indication from the network node, the indication instructing the user equipment to not send a NAS completion message following the completion of the particular action; and refraining, based on the indication, from transmitting the NAS completion message to the network node following the completion of the particular action.

In the method of the fifth example embodiment, the indication is received as part of the SIB.

In the method of the fifth example embodiment, the NAS message is expanded to include the indication.

In the method of the fifth example embodiment, the user equipment is subject to a conformance test procedure while the user equipment is in the RRC non-connected state, and the NAS message is a test control command related to the conformance test procedure.

In the method of the fifth example embodiment, the test control command is one of the following:
a command for activating a test mode;
a command for de-activating a test mode;
a command for closing a user equipment test loop; or
a command for opening a user equipment test loop.

In the method of the fifth example embodiment, the conformance test procedure is for testing validation by the user equipment of a last-used timing advance value for a configured grant small data transmission procedure.

According to sixth example embodiment, a user equipment (UE) may include means for transitioning in a radio resource control, RRC, non-connected state. The UE may also include means for receiving a system information block, SIB, from a network node. The system information block SIB includes a non-access stratum, NAS, container for conveying a NAS message to the user equipment.

In the UE of the sixth example embodiment, the RRC non-connected state includes an RRC inactive state or an RRC idle state,

In the UE of the sixth example embodiment, the SIB is an existing SIB or a new SIB.

In the UE of the sixth example embodiment, the NAS message instructs the user equipment to perform a particular action and the user equipment further comprises means for receiving an indication from the network node, the indication instructing the user equipment to not send a NAS completion message following the completion of the particular action; and means for refraining, based on the indication, from transmitting the NAS completion message to the network node following the completion of the particular action.

In the UE of the sixth example embodiment, the indication is received as part of the SIB.

In the UE of the sixth example embodiment, the NAS message is expanded to include the indication.

In the UE of the sixth example embodiment, the user equipment is subject to a conformance test procedure while the user equipment is in the RRC non-connected state, and the NAS message is a test control command related to the conformance test procedure.

In the UE of the sixth example embodiment, the test control command is one of the following:
a command for activating a test mode;
a command for de-activating a test mode;
a command for closing a user equipment test loop; or
a command for opening a user equipment test loop.

In the UE of the sixth example embodiment, the conformance test procedure is for testing validation by the user equipment of a last-used timing advance value for a configured grant small data transmission procedure.

According to a seventh example embodiment, a user equipment (UE) may include at least one processing circuitry or processor. The UE may also include at least one memory including computer program code. The at least one memory and the computer program code may be configured, with the at least one processing circuitry or processor, to cause the UE at least to transition in a radio resource control, RRC, non-connected state. The UE may also cause to receive a system information block, SIB, from a network node.

The system information block SIB includes a non-access stratum, NAS, container for conveying a NAS message to the user equipment.

In the user equipment of the seventh example embodiment, the RRC non-connected state includes an RRC inactive state or an RRC idle state.

In the user equipment of the seventh example embodiment, the SIB is an existing SIB or a new SIB.

In the user equipment of the seventh example embodiment, the NAS message instructs the user equipment to perform a particular action and the user equipment further comprises means for receiving an indication from the network node, the indication instructing the user equipment to not send a NAS completion message following the completion of the particular action. The user equipment is further caused to refrain based on the indication, from transmitting the NAS completion message to the network node following the completion of the particular action.

In the user equipment of the seventh example embodiment, the indication is received as part of the SIB.

In the user equipment of the seventh example embodiment, the NAS message is expanded to include the indication.

In the user equipment of the seventh example embodiment, the user equipment is subject to a conformance test procedure while the user equipment is in the RRC non-connected state, and the NAS message is a test control command related to the conformance test procedure.

In the user equipment of the seventh example embodiment, the test control command is one of the following:
a command for activating a test mode;
a command for de-activating a test mode;
a command for closing a user equipment test loop; or
a command for opening a user equipment test loop.

In the user equipment of the seventh example embodiment, the conformance test procedure is for testing validation by the user equipment of a last-used timing advance value for a configured grant small data transmission procedure.

According to eighth example embodiment, a computer program product may be embodied on a non-transitory computer readable medium. The computer program product may be configured to control a processor to perform a method according to the fifth embodiment.

According to any of the above example embodiments the network node may be a System Simulator (SS).

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a diagram illustrating an example of Over the Air Test (OTA TST) command for test loops;

FIG. 2 is a diagram illustrating the variation of the RSRP level in the active cell during the test;

FIG. 3 is a diagram illustrating Activate UE test mode procedure using NAS message;

FIG. 4 is a diagram illustrating Deactivate UE test mode procedure using NAS message;

FIG. 5 is a diagram illustrating Close UE test loop procedure using NAS message;

FIG. 6 is a diagram illustrating Open UE test loop procedure using NAS message;

FIG. 7 illustrates a flowchart of a method in accordance with certain embodiments;

FIG. 8 illustrates a flowchart of a method in accordance with certain embodiments;

FIG. 9 illustrates two exemplary embodiments of indicating a UE to avoid sending NAS completion message;

FIG. 10 illustrates a UE enabled to perform the method according to an example implementation;

FIG. 11 illustrates a network node enabled to perform the method according to an example implementation;

### DETAILED DESCRIPTION

As required, an exemplary-only embodiment of the present application is disclosed herein; however, it is to be understood that the disclosed embodiment is merely exemplary of the present disclosure, which may be embodied in various and/or alternative forms. Specific process details disclosed herein are not to be interpreted as limiting, but merely as a basis for the claims and as a representative basis for teaching one skilled in the art to variously employ the present disclosure in virtually any appropriately detailed processes.

Exemplary embodiments may be adapted for many different purposes and are not intended to be limited to the specific exemplary purposes set forth herein. Those skilled in the art would be able to adapt the exemplary-only embodiment of the present disclosure, depending for example, on the intended use of adapted embodiment. Moreover, examples and limitations related therewith brought herein below are intended to be illustrative and not exclusive. Other limitations of the related art will become apparent to those of skill in the art upon a reading of the following specification and a study of the related figures. The invention will be more clearly understood from the following description of the product thereof.

Some embodiments of the invention propose a method, apparatus and computer program to generally transmit a dedicated NAS message container inside a system information block whether existing or new and particularly to enable conformance testing of radio access network system (RANS) user equipment (UE) and to finding a solution to the problems encountered during such testing.

To support 5GS conformance testing, UE special conformance test functions are required. They form part of the core requirements and thus have a direct impact on the design of the UE. The UE special conformance test functions vary depending on the conformance testing functionality they are designed to support and are broadly classified into the following two groups:
Test Loop Functions: These are functions which require a loop to be established between the UE and the System Simulator (SS) to allow, e.g., DL data packets sent by the SS to be looped back UL by the UE; and
General Test Functions: These consist of commands send by the SS, e.g., to trigger a certain UE behaviour which may be a behaviour determined by 3GPP core specification requirements or such as needed to facilitate conformance testing and not being part of any 3GPP core specification requirements or to provide to the UE information needed for the conformance testing.

The utilization of any UE special conformance test functions are deemed as the equivalent of putting the UE in a test mode. The duration of the test mode depends on the UE special conformance test function and in most of the cases will be delimited by an activation and a deactivation command. The UE special conformance test functions including any relevant procedure and the Test Mode Control (TMC) message contents used for information exchange are defined in 3GPP TS 36.509 (base version for LTE) and 38.509 (extensions for NR).

The UE special conformance test functions provide access to isolated functions of the UE via the radio interface without introducing new physical interfaces just for the reason of conformance testing.

Depending on the conformance testing functionality supported, the UE special conformance test functions may comprise:

A single DL message (e.g., a test function intended to provide to the UE information needed for the conformance testing)

A Request/Acknowledgement type of 2 messages exchange, an DL message followed by a UL message, (e.g., a test function intended to request the UE to execute an action which requires acknowledgment that request was received and acted upon)

Two, or more, UE special conformance test functions may be needed to be executed in a particular sequence before a specific target UE behavior can be assumed. An example for this is the Activate UE test mode and Close UE test loop functions. The former needs to be executed first, at a particular moment of time, in order a specific type of test bearer terminated in a particular UE protocol layer to be established. Followed by the latter, executed at different point of time, which will instruct the UE to start looping back the received packets.

While testing devices, the best is to test the device as a black box and the most common use case is having the device connected to a network simulator via the air interface only. However, it is not possible in all use cases. For example, when testing data transfer, it is important for the network simulator to have control of what the device is sending. Example is UL data it is uncertain that what source is there within the device to send a specific test data set.

For such a case, specific Over the Air Test commands, OTA TST commands, are used. The test commands have their own protocol discriminator/protocol end point, a protocol running in parallel to other protocols at layer 3 level, like RRC, MM, etc. The test commands are specified in TS 38.509/TS 36.509.

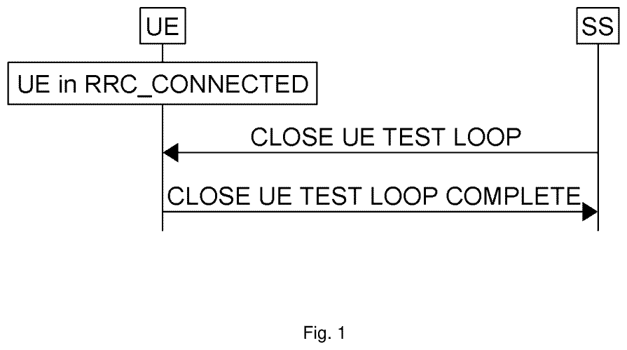

FIG. 1 illustrates that one set of commands is for loop back of data, meaning the network simulator sends data towards the device and the device is configured to send the same frames back in the uplink. The mapping between downlink and uplink and at which protocol layers can be configured.

Small data transmission (SDT) is a feature introduced in 3GPP Rel 17 for 5G NR, where small packets of data can be transmitted while the UE is in RRC INACTIVE state. This feature in intended as an energy saving feature, since the UE can stay longer periods of time in RRC INACTIVE state. There are 2 main different implementations of SDT, in one the UE transmits small transport blocks as part of the Random Access (RA) procedure while in RRC INACTIVE state, while in the other one a Configured Grant (CG) resource is allocated for the UE to transmit in RRC INACTIVE state. The last type of SDT transmission is referred to in this text as CG-SDT.

For the CG-SDT to function properly, there is a mechanism for the UE to keep synchronicity in UL. While in RRC CONNECTED state, the gNB can align the UL transmissions though a Timing Advance (TA) Command, TAC. However, when the UE is moved to RRC INACTIVE state, there are no means for the gNB to keep this message exchange and keep the UL transmissions synchronous to the UL resources. Therefore, a TA validation mechanism is defined as part of RAN2 and RAN4 CG-SDT work (Clause 5.5 of 3GPP TS 38.133) which is responsible to detect if the UE has moved. It is done by detecting changes in received signal levels and define a range in receive levels, where a level outside the range will indicate a too large change in propagation delay, which is the base for the timing advance used between the network and the UE.

The TA validation works as follows: Two RSRP values are collected, RSRP1 is collected next to the time when the TAC is received by the UE and RSRP2 is collected when the TA validation is performed for transmitting in a CG-SDT occasion.

While the UE is still in RRC CONNECTED state, when the UE receives the reference TAC command at time T1, it should perform an RSRP measurement, RSRP1 at time T1′. This measurement, RSRP1, is considered valid for the purpose of CG-SDT only if |T1-T1′|<W1, where W1 is the time window within the first RSRP value should be collected. The UE enters RRC

INACTIVE state when it receives an RRC Release with a Suspend Config message from the gNB, and it may thereafter use SDT resources for UL-SDT if this message includes the SDT configuration. For the UE to transmit in a CG-SDT resource, it must measure RSRP2 at time T2′, so that it can make the decision to transmit on CG-SDT at time T2, where T2−W2<T2′<T2, and W2 is the window where the RSRP2 measurement must be performed. Additionally, RAN4 has decided that T3−T2<=640 ms, where T3 is the time of the transmission on the CG-SDT resource and T2 is defined above. The UE may transmit on the CG-SDT occasion if it has valid RSRP1 and RSRP2 measurements (performed within W1 and W2 respectively) and if |RSRP1-RSRP2|<cg-SDT-RSRP-Change Threshold. If so, the UE shall regard the timing advance to be valid for the network to be able to receive an uplink transmission from the UE on CG-SDT resources.

Once the UE meets these requirements, it should be able to transmit with small UL timing error on a CG-SDT occasion. This transmission also has requirements for the timing accuracy, as described in clause 7.1.2 of 3GPP TS 38.133.

### Current RAN5 Test Procedure

The test procedure currently adopted for RAN5 in order to TA validation for CG-SDT in FR2 is given in Section 7.2.1 of 3GPP TS 38.533 and is also reproduced below. This test applies to all types of NR UE from Release 17 onwards that support transmission of data and/or signalling over allowed radio bearers in RRC inactive state via CG-SDT, as specified in TS 38.331.

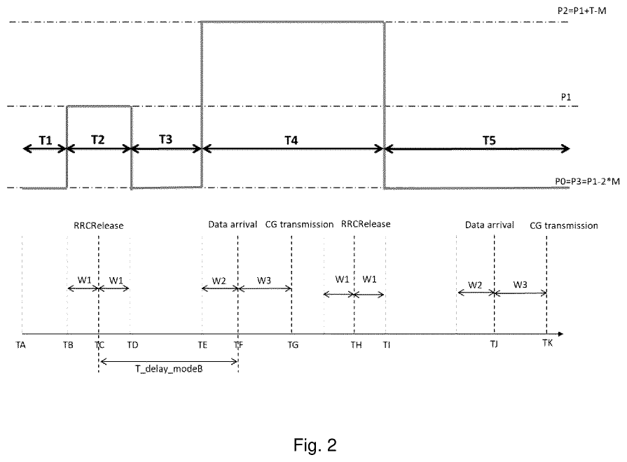

FIG. 2 of the drawings shows the variation of the RSRP level in the active cell during the test. The test procedure involves a single cell (Cell 1), configured as PCell in FR2 and consists of 5 successive time periods, with time duration of T1 to T5 respectively.

For greater clarification, the RSRP variation for TA validation for CG-SDT is set out hereunder:

Time-point TA is the starting point of the test. Prior to time point TA, the UE shall be fully synchronized and registered to PCell (Cell 1).

Time-point TB is T1 duration after TA, i.e., TB=TA+T1.

Time-point TC is the time when ‘UE Test Loop Mode B’ command (with ‘T_delay_modeB’ timer configured) and RRC Release message with CG-SDT configuration for ‘Subtest 1’ are received at the UE and is W1 duration after TB where W1=max (480 ms, 8*SMTC periodicity)), i.e., TC=TB+max(480 ms, 8*SMTC periodicity)).

Time-point TD is W1 duration after TC or T2 duration after TB, i.e., TD=TC+max (480 ms, 8*SMTC periodicity))=TB+T2.

Time-point TE is T3 duration after TD, i.e., TE=TD+T3.

Time-point TF is the time when ‘T_delay_modeB’ timer expires which trigger UL data arrival at UE lower layer and is W2 duration after the time-point TE, i.e., TF=TC+T_delay_modeB=TE+W2 (In general, TE<=TF<=TE+max (480 ms, 8*SMTC periodicity))).

Time-point TG is the time when UE transmits with CG-SDT.

Time-point TH is the time when second ‘UE Test Loop Mode B’ command (with ‘T_delay_modeB’ timer reconfigured) and second RRC Release message with CG-SDT configuration for ‘Subtest 2’ are received at the UE and is FFS in RAN4.

Time-point TI is T4 duration after TE and W1 duration after TH, i.e., TI=TE+T4=TH+W1.

Time-point TJ is the time when ‘T_delay_modeB’ timer configured in second ‘UE Test Loop Mode B’ command expires which trigger UL data arrival at UE lower layer, i.e., TJ=TH+T_delay_modeB.

Time-point TK is the end point of the first iteration of the test and is T5 duration after TI, i.e., TK=TI+T5.

The actual steps of the procedure are as follows: Ensure the UE is in state RRC_CONNECTED with generic procedure parameters Connectivity NR, Connected without release ON and Test Mode ON (Test Loop Mode B) according to TS 38.508-1 [14] clause 4.5.

Set the parameters according to Table 7.2.1.1.5-1 of TS 38.533.

The test starts at time-point TA at which SS sets the transmit power to P0.

At time-point TB, the SS changes the power level from P0 to P1.

At time point TC, the SS sends CLOSE UE TEST LOOP message (having a non-zero value of T_delay_mode B timer) and RRCRelease message with CG-SDT configuration to the UE, and the UE enters RRC_INACTIVE state.

At time-point TD, the SS changes the power level from P1 to P0.

At time-point TE, the SS changes the power level from P0 to P2.

At time-point TF, the T_delay_mode B timer expires which trigger UL data arrival at UE lower layer.

At time-point TG, the UE transmits with CG-SDT.

Check 1: If UE transmits with CG-SDT within 640 ms+Z after TF, i.e., if TF<=TG<=640 ms+Z, sub-test ‘1’ is passed.

SS sends OPEN UE TEST LOOP message to UE.

UE sends OPEN UE TEST LOOP COMPLETE message to SS.

At time-point TH, the SS sends CLOSE UE TEST LOOP message (having a non-zero value of T_delay_modeB timer) and second RRC Release message with CG-SDT configuration to UE, and the UE remains in RRC_INACTIVE state.

At time-point TI, the SS changes the power level from P2 to P3.

At time-point TJ, the T_delay_modeB timer expires which trigger UL data arrival at UE lower layer.

Check 2: If UE does not transmit with CG-SDT between TJ and TK, sub-test ‘2’ is passed.

SS sends OPEN UE TEST LOOP message to UE.

UE sends OPEN UE TEST LOOP COMPLETE message to SS.

Verdict: If both sub-tests ‘1’ and ‘2’ passed, test passes. If any of the sub-test fail, the test fails.

The test ends at time-point TK.

As far as the prior art is concerned, it is standard procedure during conformance testing of RAN5 user equipment that a system simulator (SS) sends certain test control commands, e.g., Activate UE Test Loop, Close UE Test Loop, Open UE Test Loop, Deactivate UE Test Loop commands, to the UE in downlink and the UE in turn sends acknowledgement/completion message in uplink, e.g. Activate UE Test Loop Complete, Close UE Test Loop Complete, Open UE Test Loop Complete, Deactivate UE Test Loop Complete.

System Information (SI) consists of a MIB and several SIBs, which are divided into Minimum SI and Other SI:
Minimum SI comprises basic information required for initial access and information for acquiring any other SI. Minimum SI consists of:
MIB contains cell barred status information and essential physical layer information of the cell required to receive further system information, e.g. CORESET #0 configuration. MIB is periodically broadcast on BCH.

SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

Various test modes and test commands are defined in 3GPP TS 36.509 and 3GPP TS 38.509. Test loops generally require that the PDUs to loopback are transmitted by the System Tester in the downlink. One of the defined test loop modes is called “UE test loop mode B” and allows to set a timer (integer number of seconds) so that the UE loops back the data in the UL after the timer has expired. This allows delay in the loopback function which is useful for basic SDT testing as the UE is not in RRC CONNECTED mode, receiving loop back data, when initiating an SDT procedure.

In the current 3GPP RAN5 specification TS 38.509, the test control messages, i.e., ACTIVATE TEST MODE, DEACTIVATE TEST MODE, CLOSE UE TEST LOOP, and OPEN UE TEST LOOP, are integrity protected and ciphered according to Clause 4.4 of 3GPP TS 24.301. Furthermore, the following methods are defined in the TS 38.509 to send the test control messages to the DUT.

### Activate Test Mode

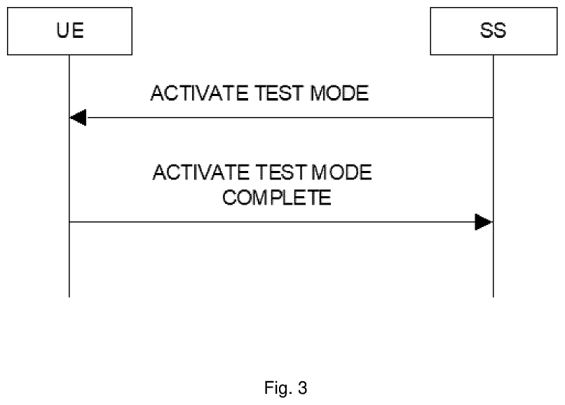

FIG. 3 shows Activate UE test mode procedure using NAS message for all scenarios. The SS uses the activate UE test mode procedure to get the UE into a test mode. The SS can activate the UE test mode when UE is in NR connected state or when UE capable of NR sidelink communication is in out-of-coverage state. The SS requests the UE to activate the UE test mode by transmitting an ACTIVATE TEST MODE message when UE is in connected state.

### Deactivate Test Mode

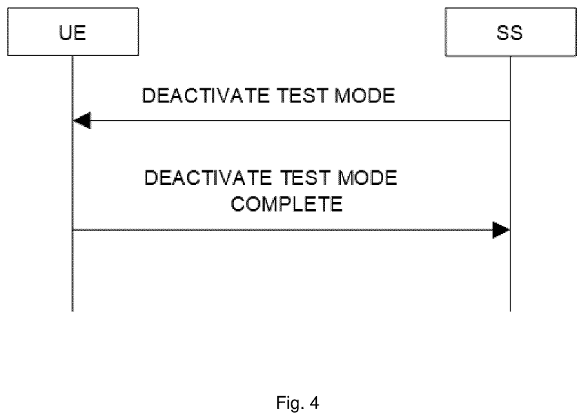

FIG. 4 shows Deactivate UE test mode procedure using NAS message for all scenarios. The purpose of this procedure is to deactivate the UE test mode and return UE to normal operation. The SS can deactivate the UE test mode when UE is in NR connected state or when UE capable of NR sidelink communication is in out-of-coverage state, and the UE test mode is active. The SS requests the UE to deactivate the UE test mode by transmitting a DEACTIVATE TEST MODE message.

### Close UE Test Loop

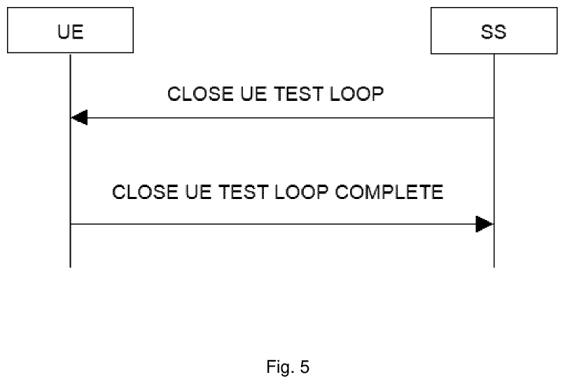

FIG. 5 shows Close UE test loop procedure using NAS message for all scenarios. The SS uses the close UE test loop procedure to start the UE Test Loop function in the UE while in NR mode or while in NR sidelink out-of-coverage state. The SS requests the UE to close UE test loop by transmitting a CLOSE UE TEST LOOP message.

### Open UE Test Loop

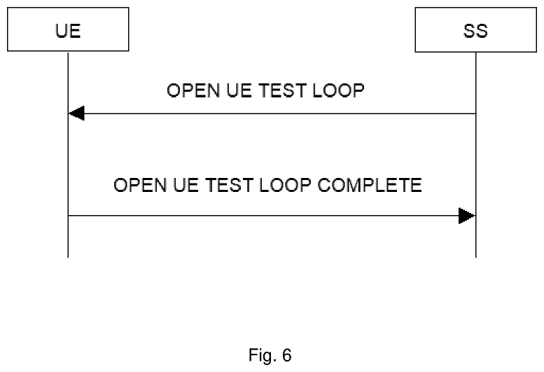

FIG. 6 shows Open UE test loop procedure using NAS message. The SS uses the open UE test loop procedure to deactivate the UE test loop function in the UE. The SS requests the UE to open all closed test loops by transmitting an OPEN UE TEST LOOP message.

In accordance with current 3GPP specification standards, the downlink test control commands are sent either as security protected NAS Layer 3 messages when the UE is in radio resource control (RRC) connected state. Thus, when using Over the Air (OTA) interface, any downlink test control command can only be sent from the SS to the UE in RRC connected state. Moreover, the uplink acknowledgement/completion message to the received downlink over the air (OTA) test control command can currently be sent only through the NAS Layer 3 messages in RRC connected state. There is currently no means or method whereby the downlink test control commands can be sent to the UE in the RRC non-connected state unless the UE initiates an SDT procedure. This presents a problem which is the object of the present invention to overcome.

The non-connected state means the UE is not in connected state i.e. the UE may either be in inactive or idle state.

In RAN5 UE conformance testing, some common steps in a standard test procedure are that System Simulator (SS) sends certain test control commands to the UE in downlink (e.g., Activate UE Test Loop, Close UE Test Loop, Open UE Test Loop, Deactivate UE Test Loop commands) and UE sends a completion message in the uplink (e.g., Activate UE Test Loop Complete, Close UE Test Loop Complete, Open UE Test Loop Complete, Deactivate UE Test Loop Complete). As per the current 3GPP specification, these commands are sent either as security protected NAS Layer 3 messages when the UE is in RRC Connected State.

At present, RAN4 and RAN5 are discussing the test procedure for testing Rel-17 SDT feature where we have 2 sub-tests in the CG-SDT RRM test case as explained below.

Subtest 1: Time point TA to TG where the correct UE behavior is to successfully perform MO-SDT (UL) at time point TG.

Subtest 2: Time point TG to TK where the correct UE behavior is NOT to perform MO-SDT (UL) at time point TK.

Referring back to FIG. 2, in the test UE receives Activate Test Mode command and Close UE test mode command in the RRC CONNECTED state on or before time point TC. At time point TC, UE received RRC Release message after which it goes to RRC INACTIVE state and remains in the INACTIVE state for the rest of the test. After time point TG, SS sends OPEN UE TEST LOOP command to the UE and then UE sends OPEN UE TEST LOOP COMPLETE command to the SS. Thereafter, SS sends CLOSE UE TEST LOOP command to the UE to configure another value for T_delay_modeB timer and then UE sends CLOSE UE TEST LOOP COMPLETE command to the SS. After time point TK, SS sends OPEN UE TEST LOOP command to the UE and then UE sends OPEN UE TEST LOOP COMPLETE command to the SS. Then, DEACTIVATE UE TEST LOOP command needs to be sent to the UE and UE needs to send DEACTIVATE UE TEST LOOP COMPLETE command to the SS.

As per the current 3GPP specification, there is no method through which these test control commands can be sent to the UE in the RRC non-connected state if the UE has not initiated an SDT procedure. This means that to send each test mode command, the UE must be brought back to the RRC CONNECTED state if it is not already in the CONNECTED state. However, this will involve additional message exchanges between SS and the UE which are unnecessary from the test point of view.

The objective of the present disclosure is to do downlink signaling while not in RRC connected mode more specifically for the purpose of device testing. The embodiments of the present disclosure may also be used generically in communication systems. The signaling shall not require, nor trigger RRC connected mode, as the entire purpose of device testing is to have the device remain in RRC non-connected state, for example to test the device maintain timing.

The non-connected state means the UE is not in connected state and may be in inactive or idle state.

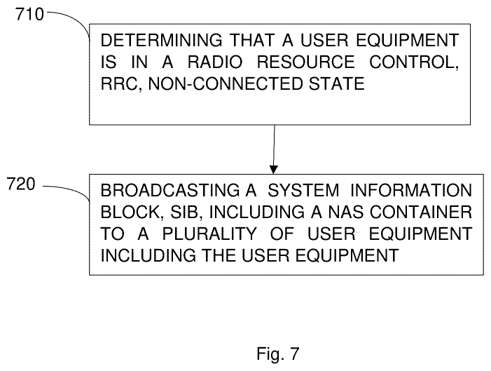

FIG. 7 illustrates a flowchart of a method in accordance with certain embodiments of the invention. The method illustrated in FIG. 7 includes, at 710, determining by the network node that a user equipment is in a radio resource control, RRC, non-connected state. The method may also include, at 720, broadcasting a system information block, sib, to a plurality of user equipment including the user equipment. The SIB includes a non-access stratum, NAS, container for conveying a NAS message to the user equipment.

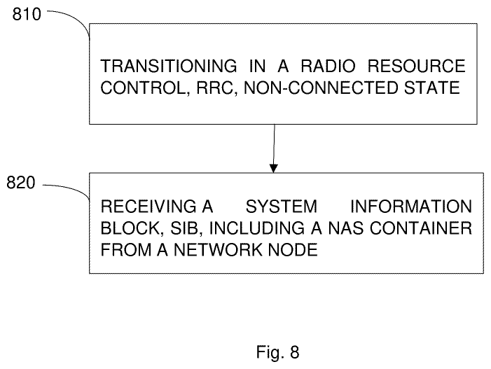

FIG. 8 illustrates a flowchart of a method in accordance with certain embodiments of the invention. The method illustrated in FIG. 8 includes, at 810, transitioning, by a user equipment in a radio resource control, RRC, non-connected state. The UE enters RRC INACTIVE state when it receives an RRC Release with a Suspend Config message from the gNB. The method may also include, at 820, receiving a system information block, SIB, from a network node. The SIB includes a non-access stratum, NAS, container for conveying a NAS message to the user equipment.

The test mode commands in a Layer 3 NAS message can be sent to the UE in the downlink even when the UE is in RRC non-connected state. Hence, UE need not be required to move back to the RRC CONNECTED state which will reduce the test time.

According to an exemplary embodiment of the invention, NAS message may be the test mode commands. The test mode commands may be used for the conformance testing of the 5GS user equipment.

Specifically to achieve this, the exemplary embodiments of the present disclosure provide at least two alternative routes described hereafter:
Route 1: Transmit the NAS message containing test control messages as an additional information element in an existing SI message, for example, SIB1.
Route 2: Transmit the NAS message containing test control messages in a newly defined SIB, defined purely as a NAS message container.

In one of the example embodiments the network node instructs at least by sending the NAS message to the UE to avoid sending the uplink completion message for a received downlink NAS message when the UE is in RRC non-connected state.

The network node transmits the NAS message indicating the user equipment to perform a particular action. The indication includes instructing the user equipment to not send a NAS completion message following the completion of the particular action.

The network node indicates the UE either through a bit inside the NAS message or through a new IE (information element) in the SIB to avoid sending the uplink completion message for the downlink NAS message.

The indication by the network node is sent via broadcast or multicast signaling along with the NAS message. The NAS message is transmitted as part of a system information block broadcasted by the network to plurality of user equipment including the user equipment.

This NAS message can be used for sending either a test mode command or a non-test mode command. In other words, any NAS message can be sent in RRC non-connected state irrespective of the fact whether the NAS command contains a test control command or not.

The instructions from the network node may be provided to UE in any of the two following ways:
Option 1: Instructing the UE to avoid sending the uplink completion message for the downlink NAS message using a bit inside the new octet in the test control message.
Option 2: Instructing the UE to avoid sending the uplink completion message for the downlink NAS message using a new IE in the SIB through which the downlink test control command was sent in non-connected state.

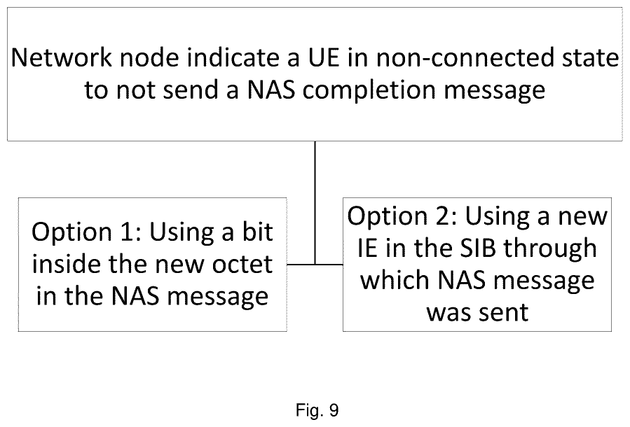

A more detailed description with respect to FIG. 9 of the drawings now follows of the routes constituting the solutions provided by the present invention by which the SS instructs the UE to avoid sending the uplink completion message for a received downlink test control command when the UE is in RRC non-connected state. Hence, UE need not be required to move back to the RRC CONNECTED state which will reduce the test time.

As already stated, this invention proposes two routes or embodiments which by sending a Layer 3 test control message to the UE in the RRC non-connected state, the network node indicates the UE either through a bit inside the test control command or through a new IE in the SIB to avoid sending the uplink completion message for this downlink NAS message.

When employing first route, the NAS message is expanded to include the indication. In one example, the NAS message containing the test control command can be expanded to include one more octet in which any one bit can be used to indicate the UE to avoid sending an UL completion message for an DL received while the UE is in RRC non-connected state. While using the first route, the NAS message containing the test control command may be transmitted through a new information element which is added to an existing SI message.

The following example shows a scenario where the OPEN UE TEST LOOP command is expanded by one octet in which the 1st bit is used to indicate the UE to avoid sending an UL completion message (OPEN UE TEST LOOP COMPLETE in this case) when the UE is in RRC INACTIVE state. Furthermore, as highlighted above, other test control commands, e.g., ACTIVATE TEST MODE, DEACTIVATE TEST MODE, CLOSE UE TEST LOOP, etc. needs to be enhanced similarly.

### EXAMPLE

Proposed Expansion of OPEN UE TEST LOOP Command according to an example embodiment—

This message is only sent in the direction SS to UE.

| Information | | | | |
|---|---|---|---|---|
| Element | Reference | Presence | Format | Length |
| Protocol | TS 24.007 [5], | M | V | ½ |
| discriminator | sub clause | | | |
| | 11.2.3.1.1 | | | |
| Skip indicator | TS 24.007 [5], | M | V | ½ |
| | sub clause | | | |
| | 11.2.3.1.2 | | | |
| Message type | | M | V | 1 |
| UL | | M (only | V | 1 |
| acknowledgement | | in RRC | | |
| | | INACTIVE/ | | |
| | | IDLE state) | | |

where message type is:

| 8 | 7 | 6 | 5 | 4 | 3 | 2 | 1 | bit no. |
|---|---|---|---|---|---|---|---|---|
| 1 | 0 | 0 | 0 | 0 | 0 | 1 | 0 | octet 1 |

and UL acknowledgement is:

| 8 | 7 | 6 | 5 | 4 | 3 | 2 | 1 | bit no. |
|---|---|---|---|---|---|---|---|---|
| 0 | 0 | 0 | 0 | 0 | 0 | 0 | X1 | octet 1 |

where X1=1 indicates that UL completion message need not be sent.

According to second aspect network node transmits the NAS message containing test control message through a new IE in any existing SIB or a newly defined SIB, defined purely as a NAS message container. The UE is indicated to avoid sending the uplink completion message for this downlink test control command using a new IE in the existing SIB or a newly defined SIB through which the downlink test control command was sent in RRC unconnected state.

Using a new IE in the existing SIB, for example, SIB1 message as follows:

-- ASN1START
-- TAG-SIB1-START
SIB1 ::= SEQUENCE {

| | |
|---|---|
| cellSelectionInfo | SEQUENCE { |
| q-RxLevMin | Q-RxLevMin, |
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| q-QualMinOffset | INTEGER (1..8) |

OPTIONAL -- Need S
}
OPTIONAL, -- Cond Standalone

| | |
|---|---|
| cellAccessRelatedInfo | CellAccessRelatedInfo, |
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |
| uac-BarringForCommon | UAC-BarringPerCatList |

OPTIONAL, -- Need S

| | |
|---|---|
| uac-BarringPerPLMN-List | UAC-BarringPerPLMN- |
| List | OPTIONAL, -- Need |

S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1- |

SelectionAssistanceInfo,

| | |
|---|---|
| individualPLMNList | SEQUENCE (SIZE |

```
(2..maxPLMN)) OF UAC-AccessCategory1-SelectionAssistance Info
      }
OPTIONAL -- Need S
  }
OPTIONAL, -- Need R
```

| | |
|---|---|
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IES |

OPTIONAL
}

| | |
|---|---|
| SIB1-v1610-Ies ::= | SEQUENCE { |
| idleModeMeasurementsEUTRA-r16 | ENUMERATED {true} |

OPTIONAL, -- Need R

| | |
|---|---|
| idleModeMeasurementsNR-r16 | ENUMERATED {true} |

OPTIONAL, -- Need R

| | |
|---|---|
| posSI-SchedulingInfo-r16 | PosSI-SchedulingInfo-r16 |

OPTIONAL, -- Need R

| | |
|---|---|
| nonCriticalExtension | SIB1-v1630-Ies |

OPTIONAL
}

| | |
|---|---|
| SIB1-v1630-Ies ::= | SEQUENCE { |
| uac-BarringInfo-v1630 | SEQUENCE { |
| uac-AC1-SelectAssistInfo-r16 | SEQUENCE (SIZE |

```
  (2..maxPLMN)) OF UAC-AC1-SelectAssistInfo-r16
  }
OPTIONAL, -- Need R
```

| | |
|---|---|
| nonCriticalExtension | SIB1-v1700-Ies |

OPTIONAL
}

| | |
|---|---|
| SIB1-v1700-Ies ::= | SEQUENCE { |
| hsdn-Cell-r17 | ENUMERATED {true} |

OPTIONAL, -- Need R

| | |
|---|---|
| uac-Barring Info-v1700 | SEQUENCE { |
| uac-BarringInfoSetList-v1700 | UAC- |

BarringInfoSetList-v1700
}
OPTIONAL, -- Cond MINT

| | |
|---|---|
| sdt-ConfigCommon-r17 | SDT-ConfigCommonSIB-r17 |

OPTIONAL, -- Need R

| | |
|---|---|
| redCap-ConfigCommon-r17 | RedCap-ConfigCommonSIB- |
| r17 | OPTIONAL, -- Need R |
| featurePriorities-r17 | SEQUENCE { |
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

OPTIONAL -- Need R
}
OPTIONAL, -- Need R

| | |
|---|---|
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | |
|---|---|
| eDRX-AllowedIdle-r17 | ENUMERATED {true} |

OPTIONAL, -- Need R

| | |
|---|---|
| eDRX-AllowedInactive-r17 | ENUMERATED {true} |

OPTIONAL, -- Cond EDRX-RC

| | |
|---|---|
| intraFreqReselectionRedCap-r17 | ENUMERATED {allowed, |
| notAllowed} | OPTIONAL, -- |

Need S

| | |
|---|---|
| cellBarredNTN-r17 | ENUMERATED {barred, notBarred} |

OPTIONAL, -- Need S

| | |
|---|---|
| nonCriticalExtension | SIB1-v1710-Ies |

OPTIONAL
}

| | |
|---|---|
| SIB1-v1710-Ies ::= | SEQUENCE { |
| dedicatedNAS-Message-INACTIVE | DedicatedNAS- |
| Message-INACTIVE | OPTIONAL, |
| NonCriticalExtension | SEQUENCE { } |

```
        OPTIONAL,
}
DedicatedNAS-Message-INACTIVE ::= SEQUENCE {
    Dedicated-Acknowledgement-Needed
    ENUMERATED{True,False}
```

| | |
|---|---|
| dedicatedNAS-Message | DedicatedNAS- |

Message
}

| | |
|---|---|
| UAC-AccessCategory1-SelectionAssistanceInfo ::= | ENUMERATED {a, |

b, c}

| | |
|---|---|
| UAC-AC1-SelectAssistInfo-r16 ::= | ENUMERATED {a, b, c, |

notConfigured}

| | |
|---|---|
| SDT-ConfigCommonSIB-r17 ::= | SEQUENCE { |
| sdt-RSRP-Threshold-r17 | RSRP-Range |

OPTIONAL, -- Need R

| | |
|---|---|
| sdt-LogicalChannelSR-DelayTimer-r17 | ENUMERATED { sf20, sf40, |
| sf64, sf128, sf512, sf1024, sf2560, spare1} | OPTIONAL, -- Need R |
| sdt-DataVolumeThreshold-r17 | ENUMERATED {byte32, |

byte100, byte200, byte400, byte600, byte800, byte1000, byte2000,
byte4000,

byte8000,

byte9000, byte10000, byte12000, byte24000, byte48000, byte96000},

| | |
|---|---|
| t319a-r17 | ENUMERATED { ms 100, |

ms200, ms300, ms400, ms600, ms1000, ms2000,

ms3000,

ms 4000, spare7, spare6, spare5, spare4, spare3, spare2, spare1}
}
RedCap-ConfigCommonSIB-r17 ::= SEQUENCE {

| | |
|---|---|
| halfDuplexRedCapAllowed-r17 | ENUMERATED {true} |

OPTIONAL, -- Need R

| | |
|---|---|
| cellBarredRedCap-r17 | SEQUENCE { |
| cellBarredRedCap1Rx-r17 | ENUMERATED {barred, |

not Barred},

| | |
|---|---|
| cellBarredRedCap2Rx-r17 | ENUMERATED {barred, |

```
notBarred}
  }
OPTIONAL, -- Need R
  ...
}
FeaturePriority-r17 ::= INTEGER (0..7)
-- TAG-SIB1-STOP
-- ASN1STOP
```

In the second option, the new SIB2x contains the dedicated NAS message container which can be used to transmit, for example, downlink conformance test control commands, to the UE in RRC non-connected state. Following is an example of the SIB2x information element according to some of the all embodiments:

-- ASN1START
-- TAG-SIB2x-START
SIB2x-r17 ::= SEQUENCE {

| | |
|---|---|
| dedicatedNAS-Message-INACTIVE | DedicatedNAS- |
| Message-INACTIVE | OPTIONAL, |
| NonCriticalExtension | SEQUENCE { } |

OPTIONAL,
}
DedicatedNAS-Message-INACTIVE ::= SEQUENCE {

| | |
|---|---|
| Dedicated-Acknowledgement-Needed | ENUMERATED{True, |

False}

| | |
|---|---|
| dedicatedNAS-Message | DedicatedNAS- |

Message
}
-- TAG-SIB2x-STOP
-- ASN1STOP

In both the above examples (SIB1 and SIB2x) of Option 2, the newly introduced field
‘Dedicated-Acknowledgement-Needed ENUMERATED {True, False}’
   will be set to ‘False’ by the network node to indicate the UE that the UL completion message is not needed. Hence, the UE will avoid sending the UL completion message while remaining in RRC non-connected state.

When employing the embodiments of the present invention the upper layers will not know how the message is received. Instead, it has been established that the test command requires a completion message and for this reason, the NAS entity will simply do just as specified. Thus, this new information makes it possible that that the NAS entity does not need to be aware of the transfer method.

According to embodiments described herein, UE avoids sending of uplink completion messages which will reduce the message exchange between the UE and the network node during the test and hence test time is reduced. Further, this method doesn't require the UE to switch back to RRC CONNECTED state therefore battery power may also be saved.

It is required to be ensured that this newly defined SIB2x is read by the UE in the test mode. One method of doing this is to define that while in test mode, the UE will always read SIB2x.

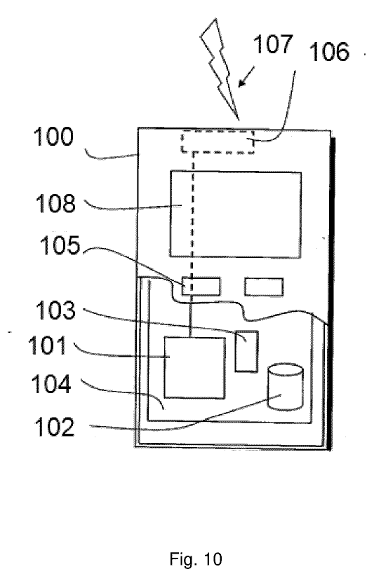

A possible mobile communication device for transmitting and retransmitting information blocks towards the stations of the system will now be described in more detail with reference to FIG. 10 showing a schematic, partially sectioned view of a communication device 100. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information. The mobile device 100 may receive signals over an air interface 207 via appropriate apparatus for receiving and may transmit signals via appropriate apparatus for transmitting radio signals. In FIG. 10 transceiver apparatus is designated schematically by block 106. The transceiver apparatus 106 may be provided for example by means of a radio part and associated antenna arrangement. The antenna arrangement may be arranged internally or externally to the mobile device.

A wireless communication device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIG. 10, multiple antennas can be provided, for example at base stations and mobile stations, and the transceiver apparatus 106 of FIG. 10 can provide a plurality of antenna ports. More data can be received and/or sent where there are more antenna elements. A station may comprise an array of multiple antennas. Signalling and muting patterns can be associated with Tx antenna numbers or port numbers of MIMO arrangements.

A mobile device is also typically provided with at least one processing circuitry (or processor or microprocessor) 101, at least one memory 102 and other possible components 103 for use in software and hardware aided execution of tasks it is designed to perform, including control of access to and communications with access systems and other communication devices. The data processing, storage and other relevant network node can be provided on an appropriate circuit board and/or in chipsets. This feature is denoted by reference 104. The user may control the operation of the mobile device by means of a suitable user interface such as key pad 105, voice commands, touch sensitive screen or pad, combinations thereof or the like. A display 108, a speaker and a microphone can be also provided. Furthermore, a mobile communication device may comprise appropriate connectors (either wired or wireless) to other devices and/or for connecting external accessories, for example hands-free equipment, thereto.

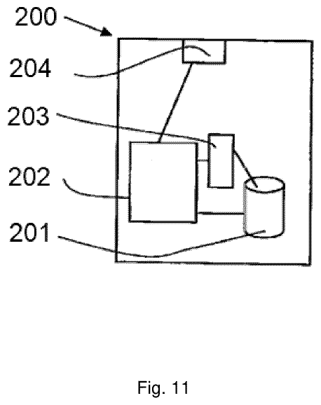

FIG. 11 shows an example of a network node. The network node 200 can be configured to provide control functions. For this purpose the network node 200 comprises at least one memory 201, at least one processing circuitry (or processor or microprocessor) 202, 203 and an input/output interface 204. The network node 200 can be configured to execute an appropriate software code to provide the control functions.

The network node may be provided in a base station. In that case, via the interface the network node may be coupled to a receiver and a transmitter. The receiver and/or transmitter may be part of a base station. That is the apparatus may comprise means for receiving and means for sending/transmitting.

The network node may alternatively or additionally be provided elsewhere in the system, for example in the S-GW. The network node may be a system simulator (SS) utilized in conformance testing.

Although FIG. 11 shows one memory 201 and two processors 202 and 203, any number of these components may be provided. Multiple functions may be carried out in a single processor, or separate functions may be carried out by separate processors. For example, a single processor may be used to make multiple determinations, or separate determinations may be made by separate processors.

The communication devices can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

This invention has advantages in comparison to existing method since it enables easy transmission of the test control command(s) embedded in Layer 3 NAS message while the UE remains in RRC INACTIVE/IDLE state. The proposed methods neither require the UE to switch back to RRC CONNECTED state nor require external AT interface. Therefore, resource and power utilization may be saved considerably.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The terms NAS message container includes NAS message, NAS container, Test Control message and have been used interchangeably.

The word “example” is used herein to mean “serving as an example, instance, or illustration.” Any embodiment described herein as “example” is not necessarily to be construed as preferred or advantageous over other embodiments. All of the embodiments described in this Detailed Description are example embodiments provided to enable persons skilled in the art to make or use the invention and not to limit the scope of the invention which is defined by the claims.

The foregoing description has provided by way of example and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1.-59. (canceled)

60. A network node comprising:
at least one processing circuitry, and
at least one memory for storing instructions to be executed by the processing circuitry, wherein the at least one memory and the instructions are configured to, with the at least one processing circuitry, cause the network node at least to:
determine that a user equipment is in a radio resource control, RRC, non-connected state;
broadcast a system information block, SIB, to a plurality of user equipment including the user equipment,
wherein the SIB includes a non-access stratum, NAS, container for conveying a NAS message to the user equipment.

61. The network node as claimed in claim 60, wherein at least one of:
the RRC non-connected state includes an RRC inactive state or an RRC idle state; or
the SIB is an existing SIB or a new SIB; or
wherein the user equipment is subject to a conformance test procedure while the user equipment is in the RRC non-connected state, and wherein the NAS message is a test control command related to the conformance test procedure; or
the NAS message instructs the user equipment to perform a particular action, and wherein the at least one memory and the instructions are further configured to, with the at least one processing circuitry, cause the network node to transmit an indication to the user equipment, the indication instructing the user equipment to not send a NAS completion message following the completion of the particular action.

62. The network node as claimed in claim 61, wherein the test control command is one of the following:
a command for activating a test mode;
a command for de-activating a test mode;
a command for closing a user equipment test loop; or
a command for opening a user equipment test loop.

63. The network node as claimed in claim 61, wherein the conformance test procedure is for testing validation by the user equipment of a last-used timing advance value for a configured grant small data transmission procedure.

64. A user equipment comprising:
means for transitioning in a radio resource control, RRC, non-connected state;
means for receiving a system information block, SIB, from a network node, wherein the SIB includes a non-access stratum, NAS, container for conveying a NAS message to the user equipment.

65. The user equipment as claimed in claim 64, wherein at least one of:
the RRC non-connected state includes an RRC inactive state or an RRC idle state; or
the SIB is an existing SIB or a new SIB; or

66. The user equipment as claimed in claim 64, wherein the NAS message instructs the user equipment to perform a particular action,
and wherein the user equipment further comprises:
means for receiving an indication from the network node, the indication instructing the user equipment to not send a NAS completion message following the completion of the particular action; and
means for refraining, based on the indication, from transmitting the NAS completion message to the network node following the completion of the particular action.

67. The user equipment as claimed in claim 66, wherein the indication is received as part of the SIB.

68. The user equipment as claimed in claim 67, wherein the NAS message is expanded to include the indication.

69. The user equipment as claimed in claim 64, wherein the user equipment is subject to a conformance test procedure while the user equipment is in the RRC non-connected state, and wherein the NAS message is a test control command related to the conformance test procedure.

70. The user equipment as claimed in claim 69, wherein the test control command is one of the following:
a command for activating a test mode;
a command for de-activating a test mode;
a command for closing a user equipment test loop; or
a command for opening a user equipment test loop.

71. The user equipment as claimed in claim 69, wherein the conformance test procedure is for testing validation by the user equipment of a last-used timing advance value for a configured grant small data transmission procedure.

72. A user equipment comprising:
at least one processing circuitry, and
at least one memory for storing instructions to be executed by the processing circuitry,
wherein the at least one memory and the instructions are configured to, with the at least one processing circuitry, cause the user equipment at least to:
transition in a radio resource control, RRC, non-connected state;
receive a system information block, SIB, from a network node,
wherein the SIB includes a non-access stratum, NAS, container for conveying a NAS message to the user equipment.

73. The user equipment as claimed in claim 72, wherein at least one of:
the RRC non-connected state includes an RRC inactive state or an RRC idle state; or
the SIB is an existing SIB or a new SIB; or
the user equipment is subject to a conformance test procedure while the user equipment is in the RRC non-connected state, and wherein the NAS message is a test control command related to the conformance test procedure.

74. The user equipment as claimed in claim 72, wherein the NAS message instructs the user equipment to perform a particular action, and
wherein the at least one memory and the instructions are further configured to, with the at least one processing circuitry, cause the user equipment to:
receive an indication from the network node, the indication instructing the user equipment to not send a NAS completion message following the completion of the particular action; and
refrain, based on the indication, from transmitting the NAS completion message to the network node following the completion of the particular action.

75. The user equipment as claimed in claim 74, wherein the indication is received as part of the SIB.

76. The user equipment as claimed in claim 75, wherein the NAS message is expanded to include the indication.

77. The user equipment as claimed in claim 73, wherein the test control command is one of the following:
a command for activating a test mode;
a command for de-activating a test mode;
a command for closing a user equipment test loop; or
a command for opening a user equipment test loop.

78. The user equipment as claimed in claim 73, wherein the conformance test procedure is for testing validation by the user equipment of a last-used timing advance value for a configured grant small data transmission procedure.
